(19) United States
(12) Patent Application Publication
(10) Pub. No.: US 2024/0074939 A1
(43) Pub. Date: Mar. 7, 2024

(54) Reusable Dysmenorrhea Relief Device

(71) Applicant: David Conroy, New York, NY (US)

(72) Inventor: David Conroy, New York, NY (US)

(21) Appl. No.: 18/456,584

(22) Filed: Aug. 28, 2023

Related U.S. Application Data
(60) Provisional application No. 63/374,457, filed on Sep. 2, 2022.

(51) Int. Cl. A61H 23/02

(52) U.S. Cl. CPC A61H 23/02; A61H 2201/0111; A61H 2205/087

(57) ABSTRACT

A dysmenorrhea relief device includes: a vibrator motor assembly, including a motor configured to vibrate; a power assembly configured to control the motor; and a connector assembly. A first end of the connector assembly couples to the vibrator motor assembly, and a second end couples to the power assembly. The connector assembly includes a connector composed of material that displace 9 mm to 65 mm in a linear stress test of 78 mm±5 mm gage length of the material at 30 N, which allows the connector assembly to be used for inserting and removing the device from a vaginal canal. In the linear stress test, 78 mm±5 mm gage length of the sample resides between grips. A linear pull force is applied to the sample at 2 mm/min. Displacement at different linear pull forces are measured until 30 N of force has been applied.

### CROSS-REFERENCE TO RELATED APPLICATIONS

The present application claims priority to U.S. Provisional Patent Application Ser. No. 63/374,457, entitled “Reusable Dysmenorrhea Relief Device” and filed Sep. 2, 2022, which is incorporated herein by reference in its entirety.

### TECHNICAL FIELD

The embodiments described herein relates to treatment of dysmenorrhea, and more particularly to a dysmenorrhea relief device.

### BACKGROUND ART

Dysmenorrhea, or painful menstruation, is suffered by at least 50% of those people who menstruate (menstruators). Menstruators most often self-treat dysmenorrhea pain with over the counter (OTC) drugs, such as acetaminophen and nonsteroidal anti-inflammatory drugs (NSAIDs). However, some menstruators prefer nonpharmacologic treatments or prefer not to rely on prescription-strength dosing of drugs when OTC drugs are insufficient to address the pain.

In some scientific studies, vibrational therapy was shown to aid in pain relief by relaxing the muscles and increasing circulation. However, conventional vibrational therapy devices are typically applied to the skin or elsewhere outside the vaginal canal. Some devices are disposable and cannot be reused. Thus, they are not economical for the consumer and not environmentally friendly.

### SUMMARY OF THE EMBODIMENTS

In accordance with one embodiment, a dysmenorrhea relief device, includes: a vibrator motor assembly, including a motor configured to vibrate at a given frequency; a power assembly configured to control the motor; and a connector assembly including a first end and a second end opposite the first end, the first end of the connector assembly coupled to the vibrator motor assembly, the second end of the connector assembly coupled to the power assembly, where the connector assembly includes a connector composed of a material that displace between 9 mm and 65 mm in a linear stress test of 78 mm±5 mm gage length of the material at 30 N.

In one embodiment, the linear stress test includes: placing a sample of the material between grips such that 78 mm±5 mm gage length of the sample resides between the grips; applying a linear pull force to the sample at a rate of 2 mm per minute; and measuring a displacement of the sample at different linear pull forces until 30 N of force has been applied.

In another aspect, the device further includes: one or more wires with a first end and a second end opposite the first end, the first end of the one or more wires electrically coupled to the motor, the second end of the one or more wire electrically coupled to the power assembly, where the one or more wires reside within a length of the connector.

In another aspect, the connector is overmolded onto the one or more wires and to a portion of the motor assembly.

### BRIEF DESCRIPTION OF THE DRAWINGS

The foregoing features of embodiments will be more readily understood by reference to the following detailed description, taken with reference to the accompanying drawings, in which:

FIG. 1A illustrates a side perspective view of a dysmenorrhea relief device according to a first embodiment.

FIG. 1B and a bottom perspective view of the dysmenorrhea relief device according to the first embodiment.

FIG. 2 illustrates an exploded view of the dysmenorrhea relief device according to the first embodiment.

FIG. 3 illustrates a close-up exploded view of the power assembly.

FIG. 4 illustrates a close-up exploded view of the battery compartment of the inner housing of the power assembly.

FIG. 5 illustrates a close-up perspective view of a second end of the connector assembly according to the first embodiment.

FIG. 6 illustrates a close-up perspective view of a first end of the connector assembly according to the first embodiment.

FIG. 7 illustrates a cross-sectional view of the vibrator motor assembly and the power assembly of the dysmenorrhea relief device according to the first embodiment.

FIG. 8 illustrates a close-up side cross-sectional view of detail M of FIG. 7, which includes the power assembly.

FIG. 9 illustrates a close-up cross-sectional view of detail K of FIG. 7, which includes the vibrator motor assembly and the first end of the connector assembly, according to the first embodiment.

FIG. 10 illustrates a cross-sectional view of the wire assembly, according to the first embodiment.

FIG. 11 illustrates a close-up perspective view of the second end of connector assembly with the wire assembly, according to the first embodiment.

FIG. 12 illustrates a cross-sectional view of the second end of the connector assembly coupled to the power assembly, according to the first embodiment.

FIG. 13 illustrates a close-up cross-sectional view of detail W of FIG. 12, which includes the second end of the connector assembly coupled to the power assembly, according to the first embodiment.

FIG. 14 illustrates a close-up perspective view of the second end of the connector assembly coupled to the power assembly, according to the first embodiment.

FIG. 15A illustrates a side perspective view of a dysmenorrhea relief device according to a second embodiment.

FIG. 15B illustrate a bottom perspective view of the dysmenorrhea relief device according to the second embodiment.

FIG. 16 illustrates an exploded view of the dysmenorrhea relief device according to the second embodiment.

FIG. 17 illustrates a cross-sectional view of the vibrator motor assembly and the power assembly of the dysmenorrhea relief device according to the second embodiment.

FIG. 18 illustrates a close-up cross-sectional view of detail N of FIG. 17, which includes the vibrator motor assembly coupled to the connector assembly, according to the second embodiment.

FIG. 19 illustrates a cross-sectional view of the connector of the connector assembly, according to the second embodiment.

FIGS. 20 and 21 illustrate close-up perspective views of the connector assembly coupled to the power assembly, according to the second embodiment.

FIG. 22 illustrates a dysmenorrhea relief device according to a third embodiment.

FIG. 23 illustrates an exploded view of the dysmenorrhea relief device according to the third embodiment.

FIG. 24A illustrates a back view of the dysmenorrhea relief device according to the third embodiment.

FIG. 24B illustrates a cross-sectional view of the dysmenorrhea relief device according to the third embodiment.

FIG. 24C illustrates a close-up cross-sectional view of the vibrator motor assembly, according to the third embodiment.

FIG. 24D illustrates a close-up cross-sectional view of the power assembly, according to the third embodiment.

FIG. 25A illustrates a side view of the dysmenorrhea relief device according to the third embodiment.

FIG. 25B illustrates a cross-sectional view of the connector assembly according to the third embodiment.

FIG. 25C illustrates a close-up cross-sectional view of the connector according to the third embodiment.

FIG. 26A illustrates the vibrator motor assembly and the connector assembly according to the third embodiment.

FIG. 26B illustrates a cross-sectional view of the vibrator motor assembly and the connector assembly according to the third embodiment.

FIG. 26C illustrates a close-up cross-sectional view of the vibrator motor assembly according to the third embodiment.

FIG. 26D illustrates a close-up cross-sectional view of the connector assembly according to the third embodiment.

FIG. 27A illustrates a tampon for use with the dysmenorrhea relief device according to the third embodiment.

FIG. 27B illustrates a boring tool with the tampon, according to the third embodiment.

FIG. 27C illustrates the tampon with the dysmenorrhea relief device according to the third embodiment.

FIG. 28 illustrates an example position of the dysmenorrhea relief device in the vagina with the user in a sitting position.

FIG. 29 illustrates another example position of the dysmenorrhea relief device in the vagina with the user in a standing position.

FIG. 30 is a diagram of an example displacement versus load curves for samples of different connector materials.

FIG. 31 is a diagram of an example chart of the displacement at 30 Newtons for different connector samples.

FIG. 32 illustrates a method of use of the dysmenorrhea relief device according to the various embodiments.

### DETAILED DESCRIPTION OF SPECIFIC EMBODIMENTS

The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

Embodiments of the reusable dysmenorrhea relief device is configured for use inside the vagina during dysmenorrhea. “Vagina,” as used herein, refers to the muscular canal that extends from the vulva to the uterus. The dysmenorrhea relief device includes a vibrator motor that may be inserted into the vagina and positioned proximate to the posterior fornix, located proximate to the utero-sacral ligaments and the Franenhauser plexus. The vibrator motor is coupled to a power assembly which powers and controls the vibrator motor. A semi-flexible connector is coupled to the vibrator motor at a first end and the power assembly at a second and opposite end. One or more wires may traverse through the length of the connector to electrically couple the vibrator motor and power assembly. The connector further functions as an applicator for the insertion and removal of the dysmenorrhea relief device into and from the vagina. The flexibility of the connector may be such that the connector accommodates the movement of the user's body in various positions without causing undue discomfort, while rigid enough to effectively function as an applicator for insertion of the dysmenorrhea relief device into the vagina and for allowing the positioning of the vibrator motor in the desired position. The dysmenorrhea relief device may be constructed to be washable and reusable.

The Figures use the following reference numerals:
100 first embodiment of the dysmenorrhea relief device
101 vibrator motor assembly according to the first embodiment 100
102 connector assembly of the first embodiment 100
103 power assembly of the first embodiment 100
201 wire assembly of the first embodiment 100
202 first end of the connector assembly 102
203 second end of the connector assembly 102
204 first housing of the power assembly 103
205 printed circuit board (PCB) assembly
206 inner housing of the power assembly 103
207 battery
208 second housing of the power assembly 103
209 connector of the connector assembly 102
401 battery compartment cover of the power assembly 103
402 battery compartment of the power assembly 103
801 button of the power assembly 103
802 dome switch of the power assembly 103
901 housing of the vibrator motor assembly 101
902 motor of the vibrator motor assembly 101
903 wire stress relief mechanism of the vibrator motor assembly 101
1001 wire jacket of the wire assembly 201
1002 wire(s) of the wire assembly 201
1101 tip of the second end 203
1102 neck of the second end 203
1103 shoulder of the second end 203
1201 channel of the power assembly 103
1202 shoulder of the channel 1201
1500 second embodiment of the dysmenorrhea relief device
1501 vibrator motor assembly of the second embodiment 1500
1502 connector assembly of the second embodiment 1500
1503 coupler of the second embodiment 1500
1504 power assembly of the second embodiment 1500
1601 wire(s) of the connector assembly 1502
1602 connector of the connector assembly 1502
1603 first end of the connector assembly 1502
1604 second end of the connector assembly 1502
1801 housing of the vibrator motor assembly 1501
1802 motor of the vibrator motor assembly 1501
1901 ribs of wire housing 1602 of the connector assembly 1502
2200 third embodiment of dysmenorrhea relief device
2201 vibrator motor assembly of third embodiment 2200
2202 tampon withdrawal string
2203 connector assembly of the third embodiment 2200
2301 vibrator motor of the vibrator motor assembly 2201
2302 front motor cover of the vibrator motor assembly 2201
2303 rear motor cover of the vibrator motor assembly 2201
2304 connector of the connector assembly 2203
2305 wires of the connector assembly 2203
2306 power assembly of the third embodiment 2200
2307 first housing of the power assembly 2306
2308 second housing of the power assembly 2306
2309 third housing of power assembly 2306
2310 printed circuit board (PCB) of the power assembly 2306
2311 battery chamber of the power assembly 2306
2312 switch of the power assembly 2306
2313 battery casing of the power assembly 2306
2502 internal ribs of the connector 2304
2601 inside surface of the rear motor cover 2303
2602 chamfer of the rear motor cover 2303
2603 flange of the rear motor cover 2303
2604 notches in the flange 2603
2701 boring tool
2702 handle of the boring tool 2701
2703 boring tip of the boring tool 2701
2704 flange of boring tool 2701
2705 tampon
2706 hole of tampon 2705

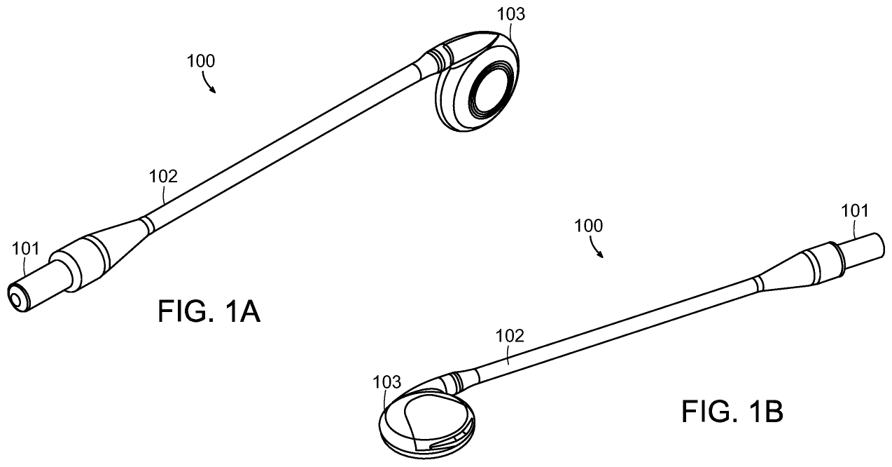

FIGS. 1A through FIG. 14 illustrate a dysmenorrhea device according to a first embodiment.

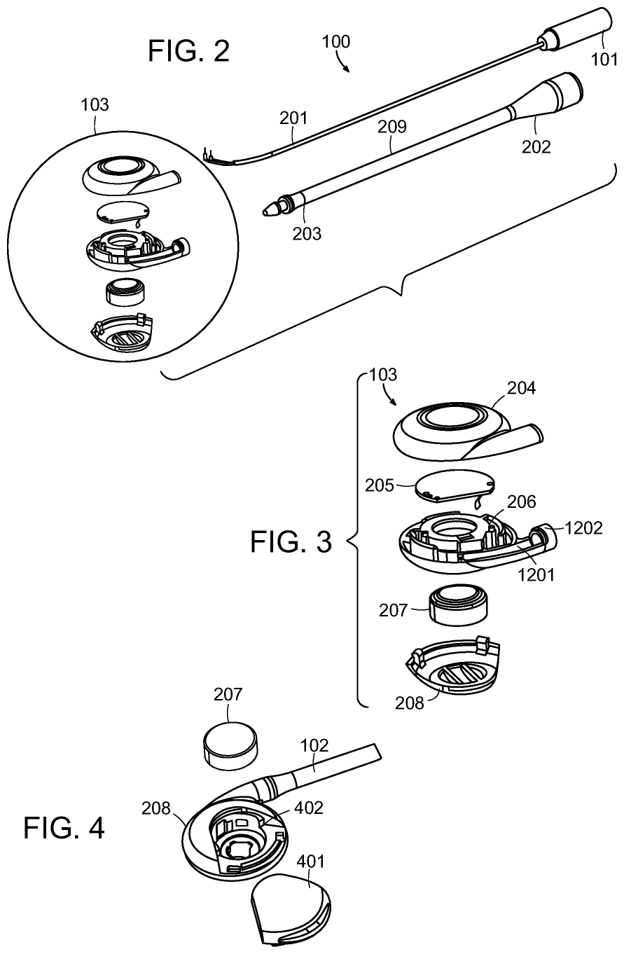

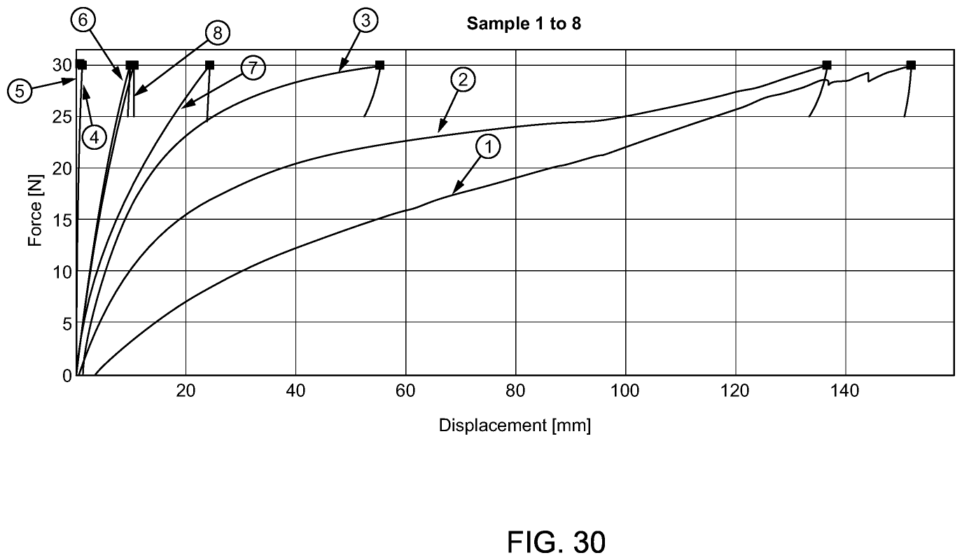

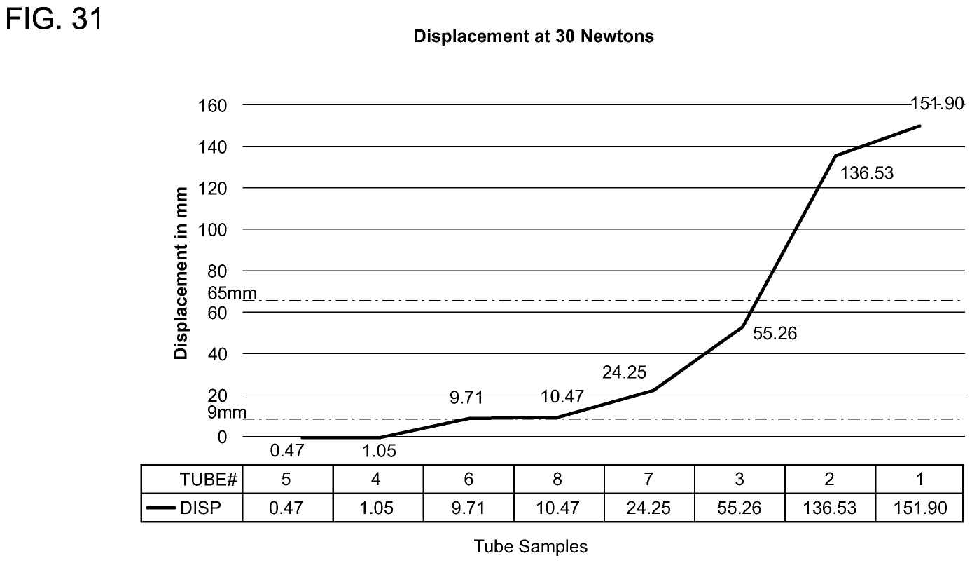

FIGS. 1A and 1B illustrate a side perspective view and a bottom perspective view, respectively, of a dysmenorrhea relief device 100 according to a first embodiment. FIG. 2 illustrates an exploded view of the dysmenorrhea relief device according to the first embodiment. Referring to FIGS. 1A, 1B, and 2, the dysmenorrhea relief device 100 includes a vibrator motor assembly 101, a connector assembly 102, and a power assembly 103. The connector assembly 102 includes a first end 202 and a second end 203 opposite the first end 202. The first end 202 of the connector assembly 102 is coupled to the vibrator motor assembly 101, and the second end 203 of the connector assembly 102 is coupled to the power assembly 103. The connector assembly 102 further includes a connector 209 coupled to the first end 202 and the second end 203, and a wire assembly 201. The connector 209 may be composed of a semi-flexible material, described further below with reference to FIGS. 30 and 31. Although the connector 209 is shown with a cylindrical shape, other shapes for the connector 209 may be used. The wire assembly 201 resides within and traverses through the connector 209. The wire assembly 201 electrically couples the vibrator motor 101 and the power assembly 103.

FIG. 3 illustrates a close-up exploded view of the power assembly 103. The power assembly 103 includes a first housing 204 and a second housing 208. Residing between the first and second housings 204, 208 are a printed circuit board (PCB) assembly 205, an inner housing 206, and a battery 207. The wire assembly 201 electrically couples the vibrator motor assembly 101 to the PCB assembly 205, which is in turn electrically coupled to the battery 207. Referring to FIG. 4, the battery 207 resides within a battery compartment 402 of the inner housing 206. The second housing 208 includes a battery compartment cover 401, which provides access to the battery compartment 402.

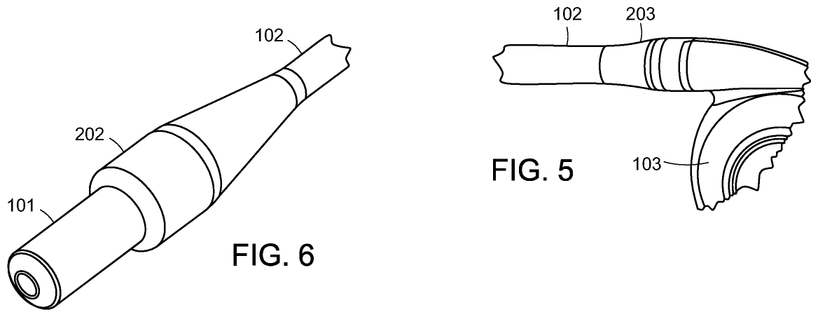

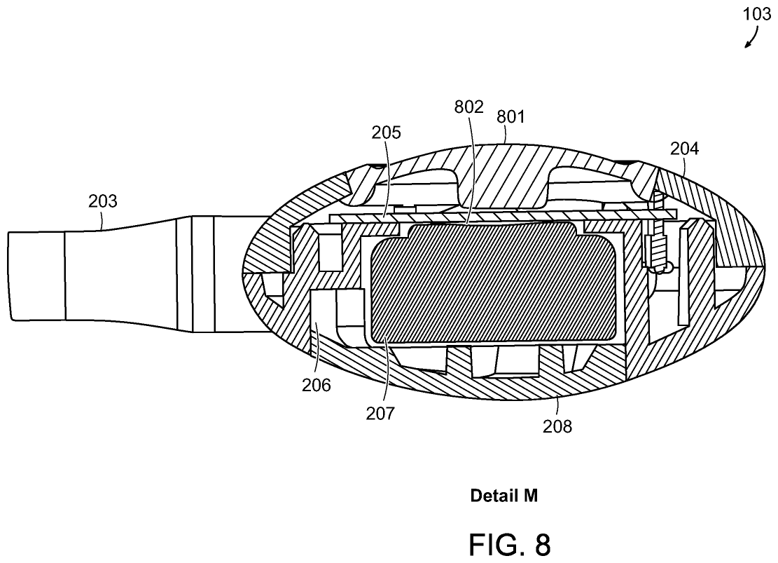

FIG. 5 illustrates a close-up perspective view of a second end 203 of the connector assembly 102. FIG. 6 illustrates a close-up perspective view of a first end 202 of the connector assembly 102. According to the first embodiment, the first end 202, the second end 203, and the connector 209 of the connector assembly 102 may be composed as a single piece. An overmolding process may be used to form the connector assembly 102 with the wire assembly 201 residing within the length of the connector 209 and to couple the first end 202 to the vibrator motor assembly 101. The second end 203 of the connector assembly 102 may be coupled to the power assembly 103, without requiring an adhesive, as described further below with reference to FIG. 8.

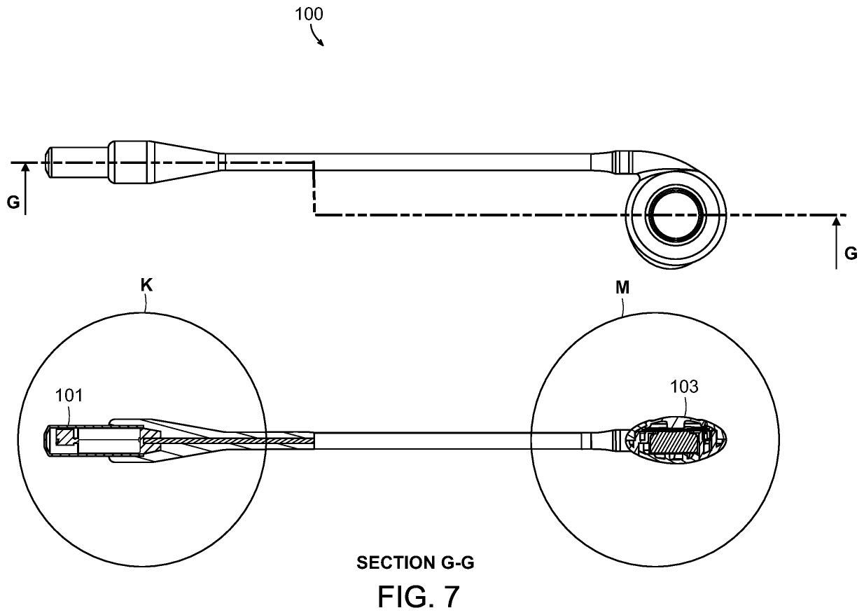

FIG. 7 illustrates a cross-sectional view of the vibrator motor assembly 101 and the power assembly 103 of the dysmenorrhea relief device 100, with an axis (G-G), according to the first embodiment. FIG. 8 illustrates a close-up side cross-sectional view of detail M of FIG. 7, which may include the power assembly 103. The power assembly 103 includes electronics (not shown) for controlling the vibrator motor assembly 101. The first housing 204 of the power assembly 103 may include a button 801 capable of engaging a side of the PCB assembly 205 opposite the battery 207. On the side of the PCB assembly 205 proximate to the battery 207 may reside a dome switch 802 capable of engaging the battery 207 and the PCB assembly 205. When the button 802 is depressed, the dome switch 802 is also depressed. The depression of the dome switch 802 engages both the battery 207 and the PCB assembly 205, which causes an electrical signal to be sent to the PCB assembly 205. The PCB assembly 205 may be configured to interpret the electrical signal to turn the vibrator motor assembly 101 ON if the vibrator motor assembly 101 is currently OFF, and to turn the vibrator motor assembly 101 OFF if the vibrator motor assembly 101 is currently ON.

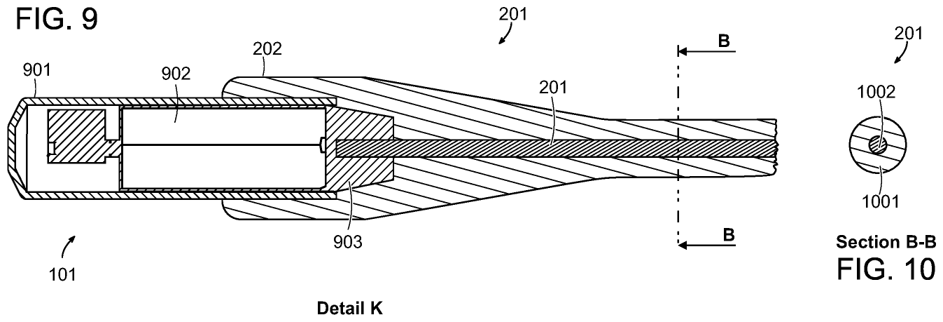

FIG. 9 illustrates a close-up cross-sectional view of detail K of FIG. 7, which includes the vibrator motor assembly 101 and the first end 202 of the connector assembly 102, according to the first embodiment. The vibrator motor assembly 101 includes a housing 901 and a motor 902 residing within the housing 901. The motor 902, when ON, produces vibrations at a predetermined frequency. In the first embodiment, the first end 202 of the connector assembly 102 is coupled to an end of the housing 901 using an overmolding process. The opposite end of the housing 901 is not overmolded. In this embodiment, the housing 901 is composed of stainless steel. Other materials may be used for the housing 901. The wire assembly 201 is electrically coupled to the motor 902 and physically coupled to the end of the housing 901. The wire assembly 201 may be physically coupled to the end of the housing 901 via a wire stress relief mechanism 903 to absorb the stress that may be applied to the coupling point between the wire assembly 201 and the motor 902.

FIG. 10 illustrates a cross-sectional view of the wire assembly 201, along axis B-B in FIG. 9, according to the first embodiment. The wire assembly 201 includes a wire jacket 1001, which encapsulates one or more wires 1002. Referring to both FIGS. 9 and 10, an end of the wire jacket 1001 physically couples to the wire stress relief mechanism 903. The wire(s) 1002 are electrically coupled to the motor 902.

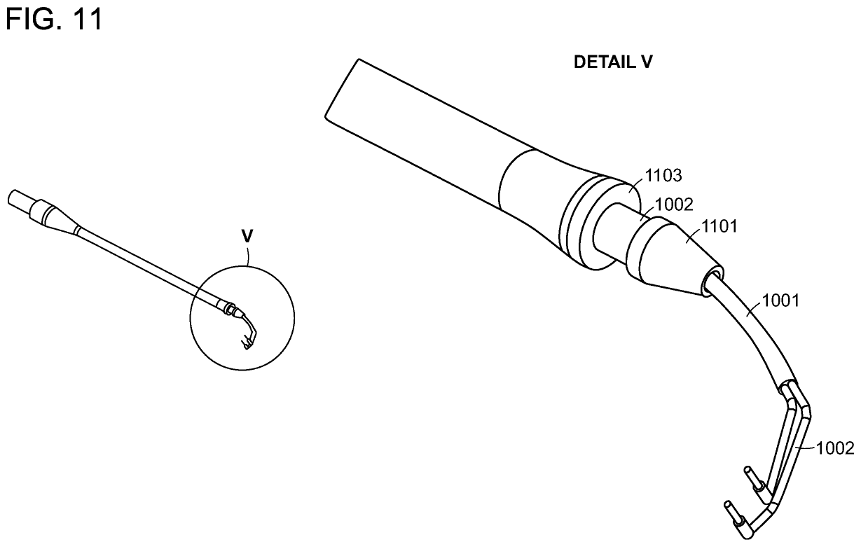

FIG. 11 illustrates a close-up perspective view of detail V, which includes the second end 203 of connector assembly 102 with the wire assembly 201, according to the first embodiment. The second end 203 of the connector assembly 102 includes a tip 1101, a neck 1102 with a first diameter, and a shoulder 1103 with a second diameter larger than the first diameter. The neck 1102 includes a first end and a second end opposite the second end. The shoulder 1103 couples to the first end of the neck 1102, and the tip 1101 coupled to the second end of the neck 1102. The tip 1101 may be a cone shape with a first end proximate to the neck 1102 and a second end distal from the neck 1102. The first end of the tip 1101 has a third diameter larger than the first diameter. The second end of the tip 1101 has a fourth diameter smaller than the third diameter. The difference between the first diameter of the neck 1102 and the second diameter of the shoulder 1103, and the difference between the first diameter of the neck 1102 and the third diameter of the tip 1101, creates a space around the neck 1102. Extending beyond the tip 1101 is a portion of the wire jacket 1001 and wire(s) 1002 of the wire assembly 201, with a portion of the wire(s) 1002 extending beyond the wire jacket 1001.

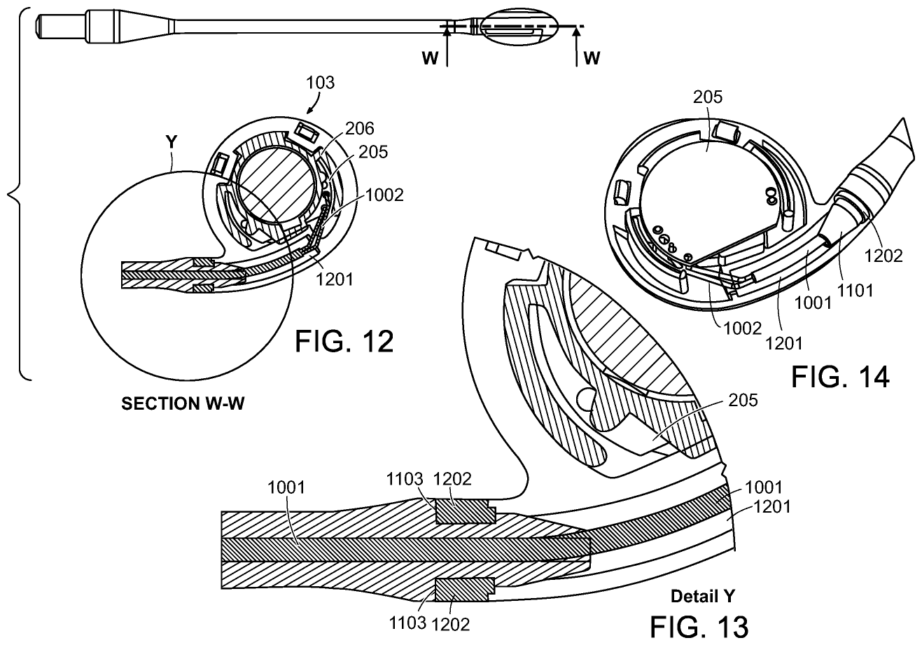

FIG. 12 illustrates a cross-sectional view of the second end 203 of the connector assembly 102 coupled to the power assembly 103, according to the first embodiment. FIG. 13 illustrates a close-up top cross-sectional view detail W in FIG. 12, which includes the second end 203 of the connector assembly 102 coupled to the power assembly 103. FIG. 14 illustrates a close-up perspective view of the second end 203 of the connector assembly 102 coupled to the power assembly 103, according to the first embodiment. Referring to FIGS. 12, 13, and 14, the inner housing 206 of the power assembly 103 forms a channel 1201 (see also FIG. 3). The channel 1201 includes a shoulder 1202 proximate to the outer opening of the channel 1201. To couple the second end 203 of the connector assembly 102 to the power assembly 103, the tip 1101 of the second end 203 may be inserted through the outer opening of the channel 1201 until the tip 1101 travels past the shoulder 1202 of the channel 1201. In the first embodiment, the connector 209 of the connector assembly 102 is composed of a semi-flexible material, described further below. The tip 1101 may be composed of the same semi-flexible material as the connector 209. The tip 1101 deforms when inserted into the outer opening of the channel 1201. When the tip 1101 travels past the shoulder 1202, the tip 1101 returns to its undeformed shape. The shoulder 1202 of the channel 1201 may be configured such that, when the tip 1101 travels past the shoulder 1202, the shoulder 1202 of the channel 1201 resides within the space around the neck 1102. The shoulder 1202 may be further configured to abut the shoulder 1103 and tip 1101 when residing within the space. The size and shape of the abutments between the shoulder 1202 and the shoulder 1103, and between the second end 203 and the tip 1101, may be configured such that disengagement of the connector assembly 102 from the power assembly 103 due to a pull force exerted on the connector assembly 102 is prevented, without requiring an adhesive. The abutments may further be configured such that a water-resistant seal is created between the connector assembly 102 and the power assembly 103. The portion of the wire jacket 1001 and the wire(s) 1002 that extend beyond the tip 1101 reside within the channel 1201. The portion of the wire(s) 1002 that extend beyond the wire jacket 1001 are physically and electrically coupled to the PCB assembly 205.

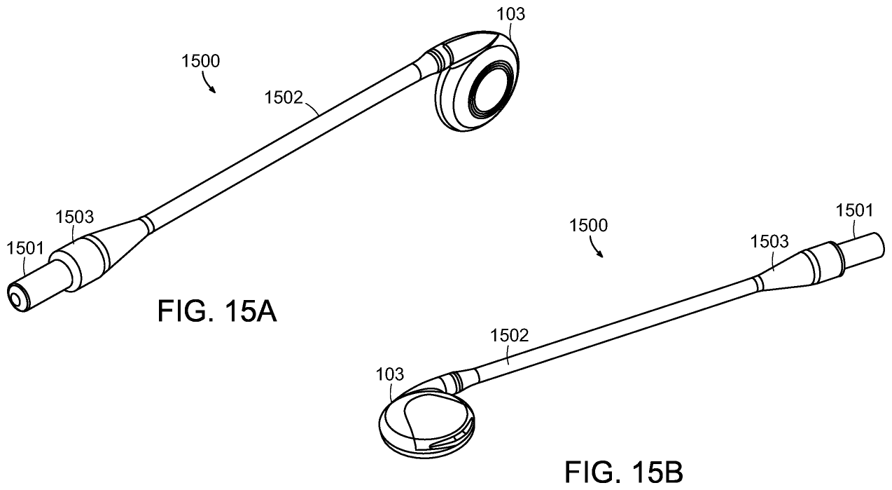

FIGS. 15A through FIG. 22 illustrates a dysmenorrhea relief device according to a second embodiment.

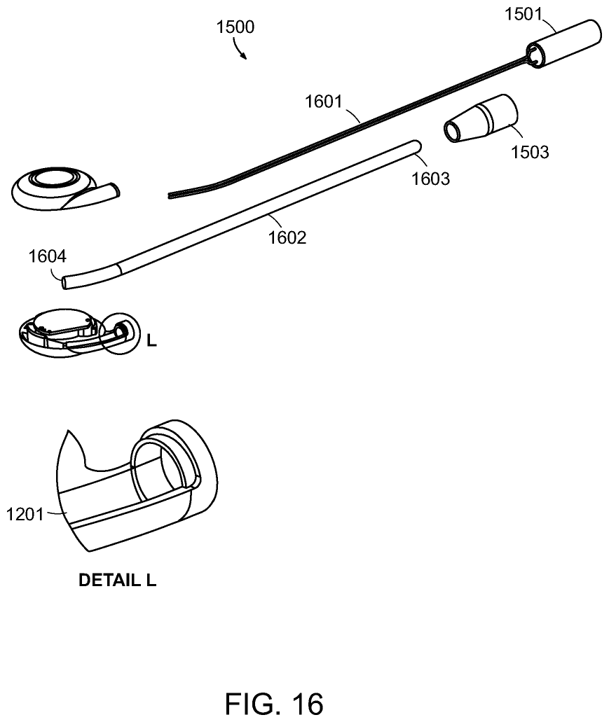

FIGS. 15A and 15B illustrate a side perspective view and a bottom perspective view, respectively, of a dysmenorrhea relief device 1500 according to a second embodiment. FIG. 16 illustrates an exploded view of the dysmenorrhea relief device 1500, with detail L, according to the second embodiment. Referring to FIGS. 15A, 15B, and 16, the dysmenorrhea relief device 1500 includes a vibrator motor assembly 1501, a connector assembly 1502, and the power assembly 103. The connector assembly 1502 includes a first end 1603, a second end 1604 opposite the first end 1603, one or more wires 1601, and a connector 1602. The wire(s) 1601 reside within and traverse the connector 1602. An end of the wire(s) 1601 extend beyond the connector 1602 and electrically couple the vibrator motor 1501 and the power assembly 103. The first end 1603 of the connector assembly 1502 is coupled to the vibrator motor assembly 1501, and the second end 1604 of the connector assembly 1502 is coupled to the power assembly 103. The dysmenorrhea relief device 1500 includes a coupler 1503 for coupling the first end 1603 of the connector assembly 1502 to the vibrator motor assembly 1501. The connector 1602 may be composed of a semi-flexible material, described further below with reference to FIGS. 30 and 31, although the connector 1602 is shown with a cylindrical shape, other shapes for the connector 1602 may be used. The power assembly 103 is described above with reference to FIGS. 3, 8, 12, 13, and 14.

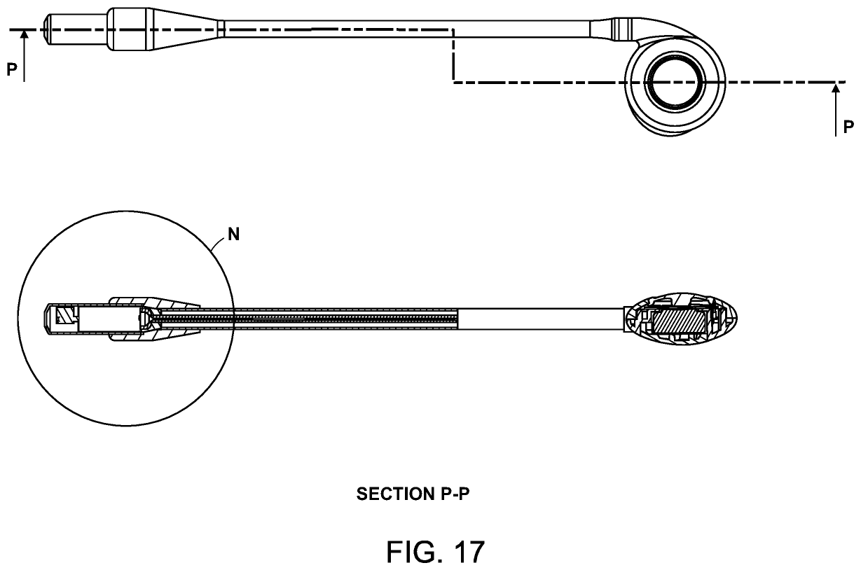

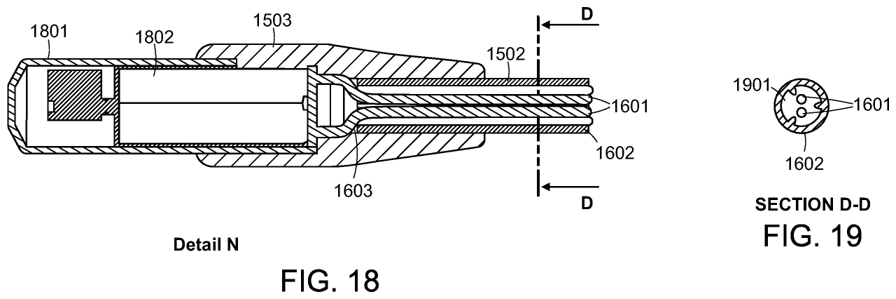

FIG. 17 illustrates a cross-sectional view of the vibrator motor assembly 1501 and the power assembly 103 of the dysmenorrhea relief device 1500, with an axis (P-P), according to the second embodiment. FIG. 18 illustrates a close-up cross-sectional view of detail N of FIG. 17, which includes the vibrator motor assembly 1501 the coupler 1503, and the first end 1603 of the connector assembly 1502, according to the second embodiment. The vibrator motor assembly 1501 includes a housing 1801 and a motor 1802 residing within the housing 1801. The motor 1802, when ON, produces vibrations at a predetermined frequency. The coupler 1503 may be coupled to one end of the housing 1801 and the first end 1603 of the connector assembly 1502. An adhesive, such as epoxy, may be used to couple the coupler 1503 to the housing 1801 and to the connector assembly 1502. The wire(s) 1601 are physically and electrically coupled to the motor 1802.

FIG. 19 illustrates a cross-sectional view of the connector of the connector assembly 1502, along axis D-D in FIG. 18, according to the second embodiment. The connector 1602 comprises a tube with an opening traversing through the length of the connector 1602. The one or more wires 1601 reside within the opening. The opening includes ribs 1901 to discourage crimping of the connector 1602, through which the wire(s) 1601 reside. The connector 1602 may comprise a tube composed of a semi-flexible material, described further below with reference to FIGS. 30 and 31. Although the connector 1602 is shown with a cylindrical shape, other shapes for the connector 1602 may be used.

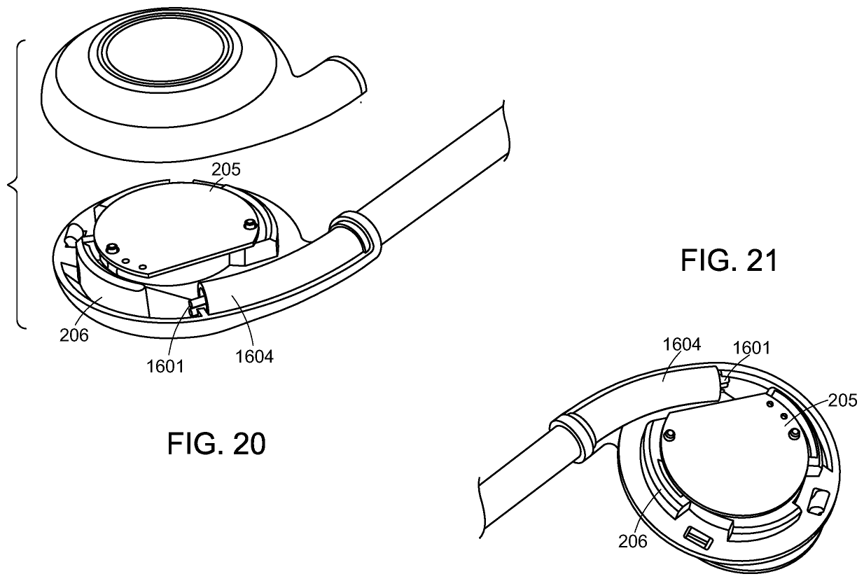

FIGS. 20 and 21 illustrate close-up perspective views of the connector assembly 1502 coupled to the power assembly 103, according to the second embodiment. Referring to FIGS. 20 and 21, the second end 1604 of the connector assembly 1502 may be inserted through an outer opening of the power assembly 103, such that the second end 1604 resides within the channel 1201 of the inner housing 206 (see Detail L in FIG. 16). An adhesive, such as epoxy, may be used to couple the second end 1604 of the connector assembly 1502 to the power assembly 103. The end of the wire(s) 1601 that extend beyond the connector 1602 are physically and electrically coupled to the PCB assembly 205.

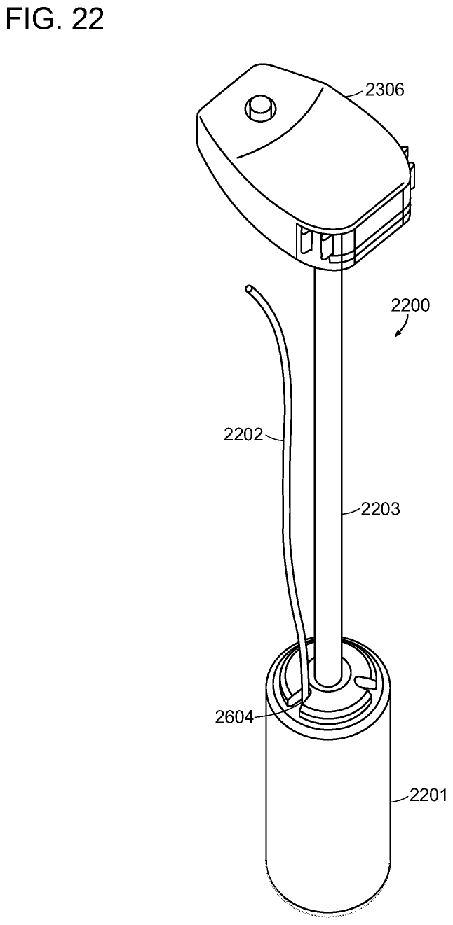

FIGS. 22 through 27C illustrate a dysmenorrhea relief device according to a third embodiment.

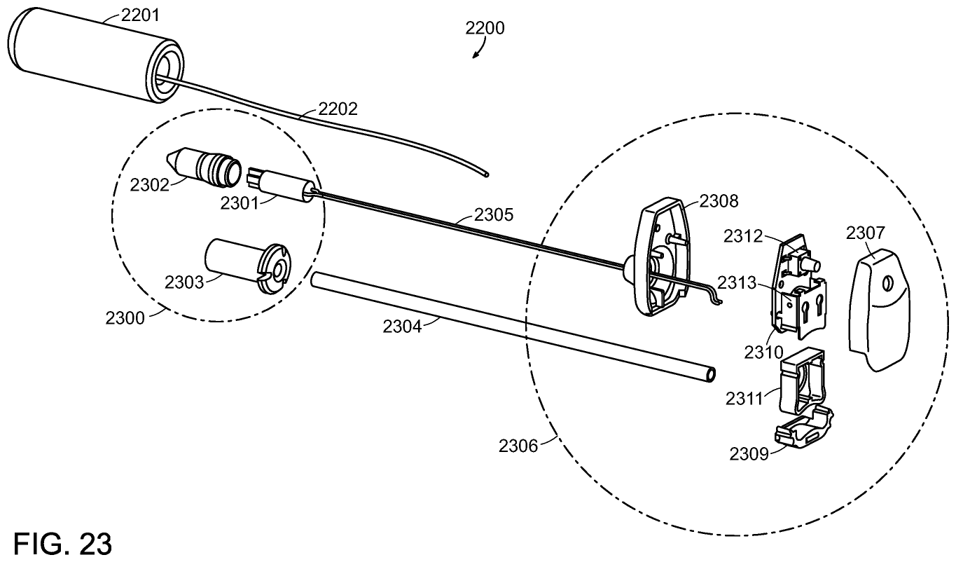

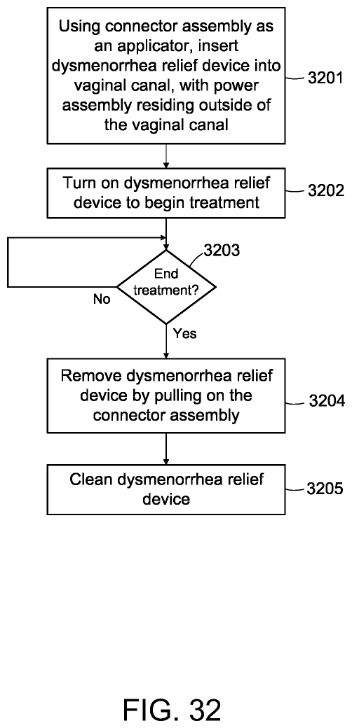

FIG. 22 illustrates a dysmenorrhea relief device 2200 according to a third embodiment. For context, the reusable dysmenorrhea relief device 2200 is shown optionally coupled to a tampon 2201 that includes a withdrawal string 2202. FIG. 23 illustrates an exploded view of the dysmenorrhea relief device 2200 according to the third embodiment. Referring to both FIGS. 22 and 23, the dysmenorrhea relief device 2200 includes a vibrator motor assembly 2300 that includes a motor 2301, a front motor cover 2302, and a rear motor cover 2303. The motor 2301 is configured to produce vibrations at a predetermined frequency. The motor 2301 resides within the front motor cover 2302 and the rear motor cover 2303, and the front motor cover 2302 is configured to protect the motor 2301. The rear motor cover 2303 is configured to provide and protect the transition between a connector 2304 and the motor 2301. The connector 2304 may comprise a tube composed of a semi-flexible material, described further below with reference to FIGS. 30 and 32. Although the connector 2304 is shown with a cylindrical shape, other shapes for the connector 2304 may be used. The connector 2304 includes a first end and a second end opposite the first end. The first end of the connector 2304 couples to the rear motor cover 2303, as described further below. The second end of the connector 2304 couples to a power assembly 2306. One or more wires 2305 electrically couple the motor 2301 to the power assembly 2306. The wire(s) 2305 may traverse the length of the connector 2304. The power assembly 2306 includes a first housing 2307, a second housing 2308, and a third housing 2309. Between the first housing 2307 and the second housing 2308 resides a printed circuit board (PCB) assembly 2310 and a battery chamber 2311. The PCB assembly 2310 includes a switch 2312 (e.g., momentary switch), a battery casing 2313, and other electronics (not visible) for controlling the motor 2301. When installed, a battery (not shown) resides within the battery chamber 2311. The opening and closing of the rear housing 2309 provides access to the battery in the battery chamber 2311.

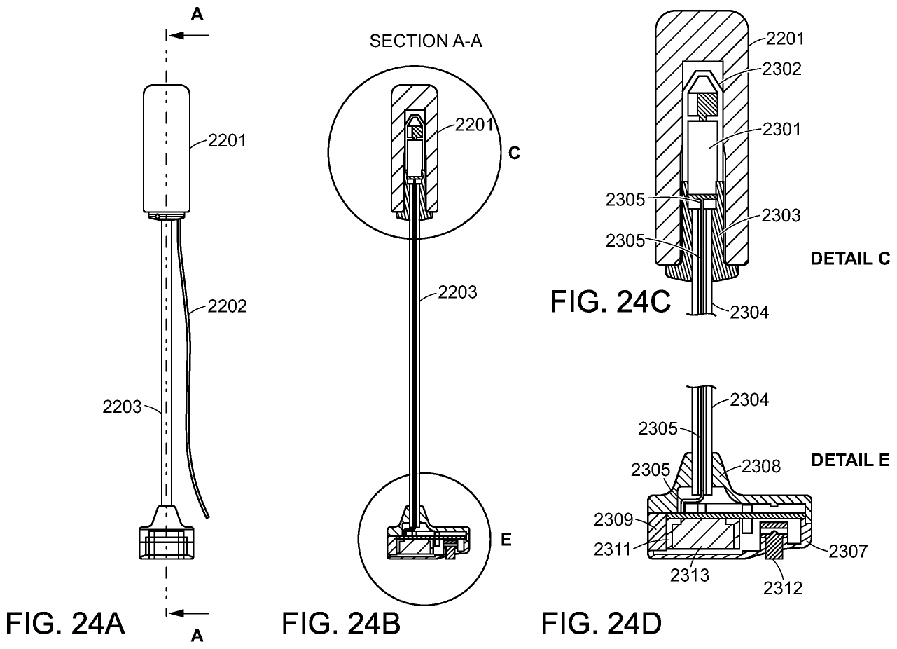

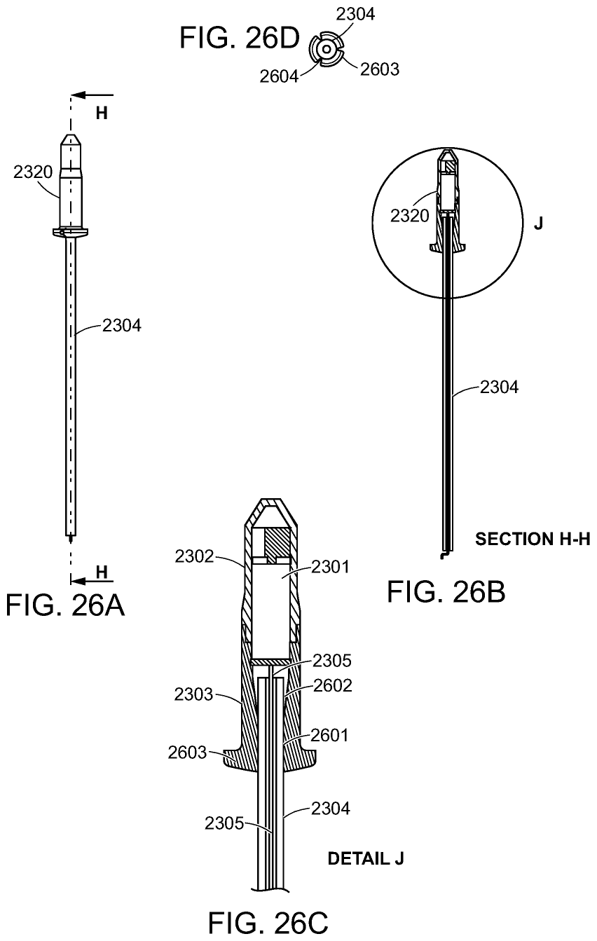

FIGS. 24A-24D illustrates the dysmenorrhea relief device 2200 in more detail, according to the third embodiment. FIG. 24A illustrates a back view of the dysmenorrhea relief device 2200, with an axis (A-A) along the length of the dysmenorrhea relief device 2200. FIG. 24B illustrates a cross-sectional view of the dysmenorrhea relief device 2200 along the A-A axis. In FIGS. 24A and 24B, the dysmenorrhea relief device 2200 is illustrated with the tampon 2201. FIG. 24C illustrates a close-up cross-sectional view of the motor assembly (illustrated in Section C of FIG. 24B) with the tampon 2201. The front motor cover 2302 is coupled to the rear motor cover 2303 using a solvent based adhesive or other means. A first end of the vibrator motor 2301 resides within the front motor cover 2302. The front motor cover 2302 functions as a protective cover for the vibrator motor 2301. The second end of the vibrator motor 2301 couples to the rear motor cover 2303. The rear motor cover 2303 is configured to protect and securely couple a first end of the connector 2304. Within the rear motor cover 2303 are the physical and electrical connections between a first end of the wires 2305 and the vibrator motor 2301. The motor assembly 2300 and its connections to the first end of the connector 2304 and wires 2306 are described further below with reference to FIGS. 26A-26C. FIG. 24D illustrates a close-up cross-sectional view of the power assembly 2306 (illustrated in Section E of FIG. 24B). The power assembly 2306 includes the first housing 2307, the second housing 2308, and the third housing 2309. The second housing 2308 physically couples to a second end of the connector 2304. The second ends of the wires 2305 traverse through the connector 2304 and are physically and electrically coupled to the PCB assembly 2310. Also coupled to the PCB assembly 2310 is the switch 2312. As described above, the first ends of the wires 2305 are coupled to the vibrator motor 2301.

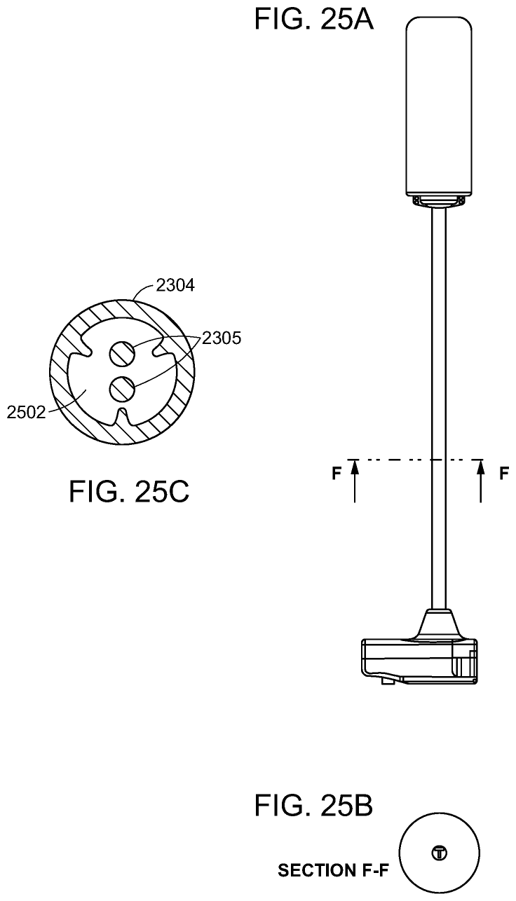

FIGS. 25A-25C illustrate the connector 2304 of the dysmenorrhea relief device 2200 in more detail, according to the third embodiment. FIG. 25A illustrates a side view of the dysmenorrhea relief device 2200 with an axis (F-F) across the connector 2304. FIG. 25B illustrates a cross-sectional view of the connector 2304 along the F-F axis. An opening traverses through the length of the connector 2304. FIG. 25C illustrates a close-up cross-sectional view of the connector 2304. The connector 2304 includes internal ribs 2502 to discourage crimping of the connector 2304, through which the wires 2305 reside, with the first ends of the wires 2305 physically and electrically coupling to the vibrator motor 2301 (see FIG. 24C), and the second ends of the wires 2305 physically and electrically coupling to the PCB assembly 2310 (see FIG. 24D).

FIG. 26A illustrates the vibrator motor assembly 2300 and the connector assembly 2203 according to the third embodiment. The vibrator motor end of the dysmenorrhea relief device 2200 is illustrated without a tampon and with an axis (H-H) along the length of the dysmenorrhea relief device 2200. FIG. 26B illustrates a cross-sectional view of the vibrator motor end of the dysmenorrhea relief device 2200 along the H-H axis. FIG. 26C illustrates a close-up cross-sectional view of section J of FIG. 26B. A first end of the vibrator motor 2301 resides within the front motor cover 2302. The front motor cover 2302 functions as a protective cover for the motor assembly 2300. The second end of the vibrator motor 2301 engages a first end of the rear motor cover 2303. The second end of the rear motor cover 2303 includes a hole through which the first end of the connector 2304 traverses. The first end of the connector 2304 is secured to the rear motor cover 2303 at an inside surface 2601 using a suitable solvent based adhesive, which functions as a strain relief junction to secure the rear motor cover 2303 to the connector 2304. At the second end of the rear motor cover 2303, the inside surface of the rear motor cover 2303 is configured with a sloping surface or chamfer 2602 to discourage the disengagement between the connector 2304 and the rear motor cover 2303. The rear motor cover 2303 protects the physical and electrical connections between the first ends of the wires 2305 and the second end of the vibrator motor 2301.

FIG. 26D illustrates an orthogonal view of the second end of the rear motor cover 203. Referring to FIGS. 26C and 26D, the second end of the rear motor cover 2303 includes a flange 2603. The flange 2603 functions as a stop, where the insertion of the dysmenorrhea relief device 2200 into the tampon 2201 stops when the flange 2603 contacts a bottom end of the tampon 2201. This ensures that the top end of the dysmenorrhea relief device 2200 does not puncture through the top end of the tampon 2201. The flange 2603 includes one or more notches 2604 for engaging the withdrawal string 2202 of the tampon 2201. This allows the free end of the withdrawal string 2202 to be available for removing the tampon 2201, if the vibrator motor assembly 2300 ever becomes disengaged from the tampon 2201 or if the connector 2304 ever becomes disengaged from the vibrator motor assembly 2300.

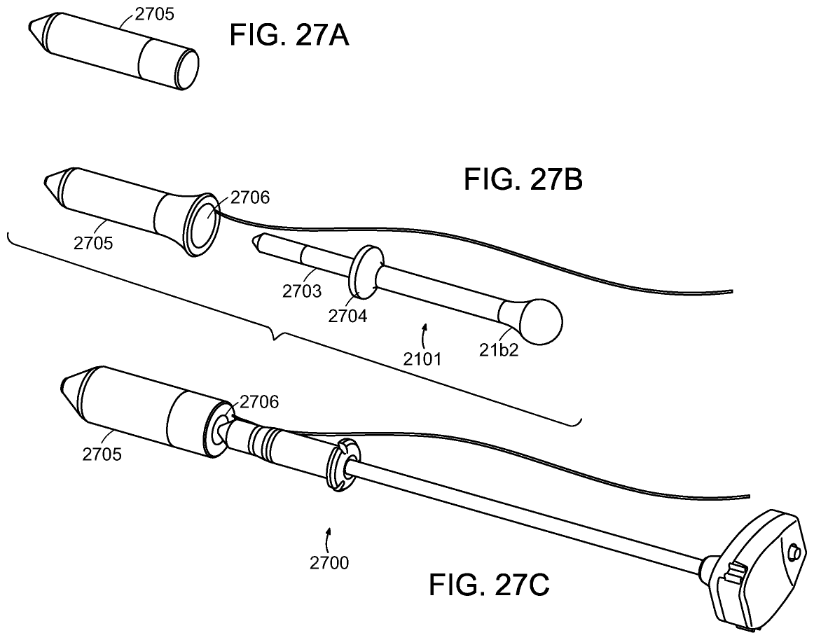

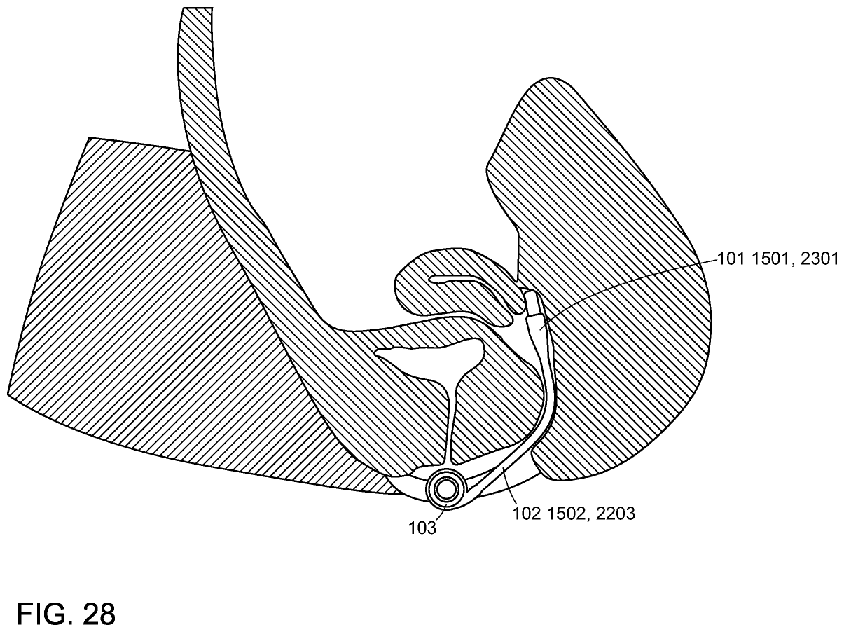

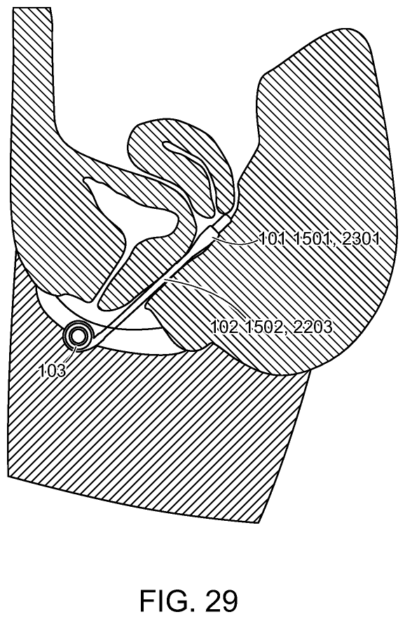

In some embodiments, the tampon 2201 is a custom tampon specifically designed to work with the dysmenorrhea relief device 2200. The custom tampon includes a preconfigured hole into which the motor assembly 2300 may be inserted. Alternatively, a solid tampon without a preconfigured hole may be used. When a solid tampon is to be used, the dysmenorrhea relief device 2200 may be offered as a stand-alone unit. A boring tool may be provided with the dysmenorrhea relief device 2200 for creating a hole in the solid tampon into which the motor assembly 2300 is to be inserted. FIGS. 27A-27C illustrate a boring tool for use with the dysmenorrhea relief device 2200. FIG. 27A illustrates the solid tampon 2705 without a hole. FIG. 27B illustrates the boring tool 2701 configured with a handle 2702, a boring tip 2703 with a tapered end, and a flange 2704. The boring tool 2701 is used to bore a hole 2706 in the solid tampon 2705, where the hole is slightly smaller than the diameter of the motor assembly 2300 so that the motor assembly 2300 snuggly resides within the hole 2706. The flange 2704 of the boring tool 2701 indicates the depth of the hole 2706 for accommodating the vibrator motor assembly 2300. The insertion of the boring tip 2703 into the solid tampon 2705 stops when the flange 2704 contacts the bottom end of the solid tampon 2705. This ensures that the boring tip 2703 does not puncture through the top of end of the solid tampon 2705. As illustrated in FIG. 27C, once the hole 2706 is created, the dysmenorrhea relief device 2200 is inserted into the hole 2706.

In an alternative embodiment, a non-absorbent protective covering is used with the dysmenorrhea relief device 2200 instead of a tampon. With the non-absorbent protective covering, the dysmenorrhea relief device 2200 may be used when no or minimal menstrual blood is flowing. The dysmenorrhea relief device 2200 with the non-absorbent protective covering may be inserted into the vagina using a suitable lubricant.

FIG. 28 illustrates an example position of the embodiments of the dysmenorrhea relief device 100, 1500, 2200 in the vagina with the user in a sitting position. In the sitting position, the shape of the vagina is curved, and the connector assembly 102, 1502, 2203 of the embodiments of the dysmenorrhea relief device 100, 1500, 2200 flexes to conform to the curved shape of the vagina without causing undue discomfort. FIG. 29 illustrates another example position of the dysmenorrhea relief device 100, 1500, 2200 in the vagina with the user in a standing position. In this position, the vagina is comparatively less curved. FIGS. 28 and 29 are offered to show general shapes of the vagina and the positions of the dysmenorrhea relief device 100, 1500, 2200 for illustrative purposes only and are not offered as anatomically precise representations. As the user moves from the position in FIG. 28 to the position in FIG. 29, or vice versa, the connector 209, 1602, 2304 flexes to conform to the changing shape of the vagina. The dysmenorrhea relief device 100, 1500, 2200 is inserted into the vagina such that the vibrator motor assembly 101, 1501, 2301 may be positioned proximate to the posterior fornix, located proximate to the utero-sacral ligaments and the Franenhauser plexus. The connector 209, 1602, 2304 may be configured to function as an applicator to insert the dysmenorrhea relief device 100, 1500, 2200 into the vagina. The connector 209, 1602, 2304 remains in place in the vagina, with the power assembly 103, 2306 residing outside of the vagina. The connector 209, 1602, 2304 continues to reside in the vagina throughout the treatment and while the user performs daily activities, such as sitting, walking, running, and other activities. Each of these activities affects the shape and orientation of the vagina. The natural shape of the vagina is not straight. The vagina tilts posteriorly between the urethra and rectum, with the urethra bound to its anterior wall. If standing, the vagina will point in an upward-backward direction to form a 45-degree angle with the uterus and an about 60-degree angle to the horizontal. However, the exact angles are variable depending on individual anatomy and with the contents of the bladder and colon. Further, the shape of the vagina changes as the user moves, such as when one crosses her legs, sits/stands, twists, etc. Since the treatment occurs over a period of time, the flexibility of the connector 209, 1602, 2304 must accommodate the movement of the user's body in various positions without causing undue discomfort.

To realize this conformity to the flexible nature of the vagina, the connector 209, 1602, 2304 is composed of materials within certain ranges for a set of parameters. To test the value of the parameters for a certain connector material, a linear stress test, or pull test, of a sample of the connector material (by itself and without any wires or other components of the dysmenorrhea relief device 100, 1500, 2200) is conducted. From the linear stress test, a measurement of elasticity that remains non-deforming in the area designed by Hooke's Law may be obtained for a particular sample. The measurement of elasticity is based on the displacement of the sample due to the linear stress applied to the sample. Each sample may then be use-tested to determine the range of elasticity of the connector material that allows the connector assembly to be effectively used as an applicator. For example, the linear stress test is conducted in a room temperature of approximately 23° C. For at least 48 hours prior to the linear stress test, the sample is stored at about 23° C. The sample is placed between grips such that 78 mm±5 mm gage length resides between the grips. A linear force is applied to the sample at a rate of 2 mm per minute. During the linear stress test, the displacement of the sample at different applied forces are measured until 30 N of force has been applied. The displacement of the sample at 30 N, as well as a load vs. displacement curve, may be reported. FIG. 30 is a diagram of an example displacement versus load curves (1-8) for samples of eight different tube samples. One or more of the samples may be composed of different materials. One or more of the samples may be composed of the same material with different properties, such as durometer. FIG. 31 is a diagram of an example chart of the displacement at 30 N for different tube samples. Based on the results of the linear stress test on the samples and the use-tests, it may be determined that materials resulting in a displacement between 9 mm and 65 mm when pulled at 30 N provide the range of flexibility that allows the connector 209, 1602, 2304 to be used as an applicator. Optionally, a diameter of the connector material may be a parameter, where the diameter may be set based on the user experience, e.g., comfort level during use of the device.

FIG. 32 illustrates a method of use of the dysmenorrhea relief device 100, 1500, 2200 according to the various embodiments. Prior to use, the user inserts, replaces, or recharges and inserts the battery of the dysmenorrhea relief device 100, 1500, 2200 if necessary. Any battery or battery recharging technology may be used. Using the connector assembly 102, 1502, 2203 as an applicator, the user inserts the dysmenorrhea relief device 100, 1500, 2200 into the vagina, with the power assembly 103, 2306 residing outside of the vagina (3201). The user turns on the dysmenorrhea relief device 100, 1500, 2200 to begin treatment (3202). The treatment continues for a predetermined period of time. For example, the treatment may continue until the user turns off the dysmenorrhea relief device 100, 1500, 2200. For another example, the treatment may run for the duration of the battery life. Once the treatment ends (3203), the user removes the dysmenorrhea relief device 100, 1500, 2200 and by pulling on the connector assembly 102, 1502, 2203 (3204). The user then cleans the dysmenorrhea relief device 100, 1500, 2200 (3205). The battery may be removed prior to cleaning. The user may determine whether the dysmenorrhea has been alleviated. If so, then the dysmenorrhea relief device 100, 1500, 2200 can be stored for subsequent use. If not, the user may repeat the treatment (3201-3205), inserting another battery if necessary. The number of treatments may also be conducted as prescribed by a physician.

In a preferred embodiment, certain connections and joinery of the dysmenorrhea relief device 100, 1500, 2200 may be sealed to allow the dysmenorrhea relief device 100, 1500, 2200 to be water resistant or water submersible. For example, the coupling of the connector assembly 102, 1502, 2203 to the vibrator motor assembly 101, 1501, 2201, and the coupling of the connector assembly 102, 1502, 2203 to the power assembly 103, 2306, may be water resistant or water submersible.

In some embodiments, the PCB assembly 205, 2310 is configured with the capability to vary the frequency at which the motor 902, 1802, 2301 vibrates, and an additional control can be added to the power assembly 103, 2306 to allow the user to set the frequency

In some embodiments, the power assembly 103, 2306 is configured to include a wireless transceiver capable of communicating with a wireless device, such as a mobile device. For example, an application residing on the mobile device may be configured to communicate with the wireless transceiver to turn the motor 902, 1802, 2301 ON/OFF, to adjust the frequency of the vibration, to set the duration of the treatment, or to monitor battery life.

In some embodiment, the PCB assembly 205, 2310 includes a microprocessor configured to store preset treatment parameters (e.g., frequency, amplitude, duration, etc.). The microprocessor may be configured to set maximum limits for one or more of the treatment parameters to ensure the safety of the user. The microprocessor may further be configured to perform an action in response to specific triggers. For example, the microprocessor may turn off the motor 902, 1802, 2301 when an unsafe condition is detected, such as the motor 902, 1802, 2301 exceeds a temperature threshold.

In an alternative embodiment, the power assembly 103, 2306 is configured to reside proximate to the vibrator motor assembly 101, 1501, 2201, where the power assembly 103, 2306 and vibrator motor assembly 101, 1501, 2201 both reside within the vagina during treatment. The PCB assembly 205, 2310 of the power assembly 103, 2306 includes a wireless transceiver, and the vibrator motor assembly 101, 1501, 2201 is controlled by the user through communications with an application on a wireless device. Here, no wires traverse within the connector.

Other Considerations

All components of the device and their locations, electronic communication methods between the system components, magnet types, cables, wiring, attachment or securement mechanisms, mechanical connections, electrical connections, dimensions, values, materials, charging methods, battery types, applications/uses, tools and devices that can be used therewith, etc. discussed above or shown in the drawing, if any, are merely by way of example and are not considered limiting and other component(s) and their locations, electronic communication methods, magnet types, cables, wiring, attachment or securement mechanisms, mechanical connections, electrical connections, dimensions, values, materials, charging methods, battery types, applications/uses, tools and devices that can be used therewith, etc. can be chosen and used and all are considered within the scope of the disclosure.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.).

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Unless otherwise indicated, “about” and/or “approximately” as used herein when referring to a measurable value such as an amount, a temporal duration, and the like, encompasses variations of 20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of 20% or 10%, ±5%, or +0.1% from the specified value, as appropriate in the context of the systems, devices, circuits, methods, and other implementations described herein.

The embodiments of the invention described above are intended to be merely exemplary; numerous variations and modifications will be apparent to those skilled in the art. All such variations and modifications are intended to be within the scope of the present invention as defined in any appended claims.

### Implementation Examples

Without limitation, potential subject matter that may be claimed (prefaced with the letter “P” so as to avoid confusion with the actual claims presented below) includes:

P1. A dysmenorrhea relief device, comprising: a vibrator motor assembly, comprising a motor configured to vibrate at a given frequency; a power assembly configured to control the motor; and a connector assembly comprising a first end and a second end opposite the first end, the first end of the connector assembly coupled to the vibrator motor assembly, the second end of the connector assembly coupled to the power assembly, wherein the connector assembly comprises a connector composed of a material that displace between 9 mm and 65 mm in a linear stress test of 78 mm±5 mm gage length of the material at 30 N.

P2. The device of P1, wherein the linear stress test comprises: placing a sample of the material between grips such that 78 mm±5 mm gage length of the sample resides between the grips; applying a linear pull force to the sample at a rate of 2 mm per minute; and measuring a displacement of the sample at different linear pull forces until 30 N of force has been applied.

P3. The device of P1, further comprising: one or more wires with a first end and a second end opposite the first end, the first end of the one or more wires electrically coupled to the motor, the second end of the one or more wire electrically coupled to the power assembly, wherein the one or more wires reside within a length of the connector.

P4. The device of P3, wherein the connector is overmolded onto the one or more wires and to a portion of the motor assembly.

P5. The device of P3, wherein the second end of the connector assembly comprises: a neck comprising a first diameter, a first end, and a second end opposite the first end; a shoulder of the connector assembly coupled to a first end of the neck and comprising a second diameter larger than the first diameter; a tip coupled to the second end of the neck, the tip comprising a first end proximate to the neck and a second end distal from the neck, the first end of the tip having a third diameter larger than the first diameter, the second end of the tip having a fourth diameter smaller than the third diameter, wherein a space is formed around the neck; a wire jacket residing within the connector, wherein a portion of the wire jacket extends beyond the second end of the tip; and the one or more wires residing within the wire jacket, wherein a portion of the one or more wires extend beyond the wire jacket.

P6. The device of P3, wherein the power assembly comprises: an inner housing comprising a channel, the channel comprising an outer opening and a shoulder proximate to the outer opening, wherein when the second end of the connector assembly couples to the power assembly, the tip resides within the channel, wherein the shoulder of the inner housing resides within the space around the neck, wherein the shoulder of the inner housing abuts the shoulder of the second end of the connector assembly and abuts the second end of the tip, wherein the portion of the one or more wires extending beyond the wire jacket traverse the channel.

P7. The device of P6, wherein the shoulder of the inner housing abutting the shoulder of the second end of the connector assembly and abutting the second end of the tip form a water resistant seal.

P8. The device of P6, wherein the second end of the connector assembly is coupled to the power assembly without using an adhesive.

P9. The device of P3, wherein the connector comprises a tube with an opening traversing the length of the connector, wherein the one or more wires reside within the opening.

P10. The device of P1, wherein the vibrator motor assembly comprises a housing, wherein the motor resides within the housing, wherein the device further comprises a coupler coupled to the first end of the connector assembly and to a portion of the housing of the vibrator motor assembly.

P11. The device of P10, wherein the coupler is coupled to the first end of the connector assembly and to a portion of the housing of the vibrator motor assembly using an adhesive.

P12. The device of P3, wherein the vibrator motor assembly further comprises: a front motor cover configured for the motor to reside within the front motor cover; and a rear motor cover configured to couple to the first end of the connector assembly, wherein a coupling of the one or more wires to the motor resides within the rear motor cover.

P13. The device of P12, wherein an inside surface of the rear motor cover comprises a chamfer coupled to the first end of the connector assembly.

P14. The device of P12, wherein the rear cover comprises a flange at an end proximate to the first end of the connector assembly, the rear motor cover comprising one or more notches configured to engage a withdrawal string coupled to a tampon.

P15. The device of P1, wherein the power assembly comprises: a printed circuit board (PCB) assembly configured to control the motor; and a switch coupled to the PCB assembly.

P16. A dysmenorrhea relief device, comprising: a vibrator motor assembly, comprising a motor configured to vibrate at a given frequency; a power assembly configured to control the motor; and a connector assembly comprising a first end and a second end opposite the first end, the first end of the connector assembly coupled to the vibrator motor assembly, the second end of the connector assembly coupled to the power assembly, wherein the connector assembly comprises a connector composed of a material that displace between 9 mm and 65 mm in a linear stress test of 78 mm±5 mm gage length of the material at 30 N, wherein the connector assembly further comprises one or more wires with a first end and a second end opposite the first end, the first end of the one or more wires electrically coupled to the motor, the second end of the one or more wire electrically coupled to the power assembly, wherein the one or more wires reside within a length of the connector.

P17. A dysmenorrhea relief device, comprising: a vibrator motor assembly, comprising a motor configured to vibrate at a given frequency; a power assembly configured to control the motor; and a connector assembly comprising a first end and a second end opposite the first end, the first end of the connector assembly coupled to the vibrator motor assembly, the second end of the connector assembly coupled to the power assembly, wherein the connector assembly comprises a connector composed of a material that displace between 9 mm and 65 mm in a linear stress test of 78 mm±5 mm gage length of the material at 30 N, wherein the connector comprises a tube with an opening traversing the length of the connector, wherein the one or more wires reside within the opening.

P18. A method for providing dysmenorrhea relief, comprising: inserting a dysmenorrhea relief device into a vaginal canal, the dysmenorrhea relief device comprising: a vibrator motor assembly, comprising a motor configured to vibrate at a given frequency; a power assembly configured to control the motor; and a connector assembly comprising a first end and a second end opposite the first end, the first end of the connector assembly coupled to the vibrator motor assembly, the second end of the connector assembly coupled to the power assembly, wherein the connector assembly comprises a connector composed of a material that displace between 9 mm and 65 mm in a linear stress test of 78 mm±5 mm gage length of the material at 30 N, wherein the connector assembly is used to insert the dysmenorrhea relief device; turning on the dysmenorrhea relief device to begin treatment; continuing the treatment for a period of time; at the end of the period of time, turning off the dysmenorrhea relief device; and remove the dysmenorrhea relief device from the vaginal canal using the connector assembly.

What is claimed is:

1. A dysmenorrhea relief device, comprising:
a vibrator motor assembly, comprising a motor configured to vibrate at a given frequency;
a power assembly configured to control the motor; and
a connector assembly comprising a first end and a second end opposite the first end, the first end of the connector assembly coupled to the vibrator motor assembly, the second end of the connector assembly coupled to the power assembly,
wherein the connector assembly comprises a connector composed of a material that displaces between 9 mm and 65 mm in a linear stress test of 78 mm±5 mm gage length of the material at 30 N.

2. The device of claim 1, wherein the linear stress test comprises:
placing a sample of the material between grips such that 78 mm±5 mm gage length of the sample resides between the grips;
applying a linear pull force to the sample at a rate of 2 mm per minute; and
measuring a displacement of the sample at different linear pull forces until 30 N of force has been applied.

3. The device of claim 1, further comprising:
one or more wires with a first end and a second end opposite the first end, the first end of the one or more wires electrically coupled to the motor, the second end of the one or more wire electrically coupled to the power assembly,
wherein the one or more wires reside within a length of the connector.

4. The device of claim 3, wherein the connector is overmolded onto the one or more wires and to a portion of the motor assembly.

5. The device of claim 3, wherein the second end of the connector assembly comprises:
a neck comprising a first diameter, a first end, and a second end opposite the first end;
a shoulder of the connector assembly coupled to a first end of the neck and comprising a second diameter larger than the first diameter;
a tip coupled to the second end of the neck, the tip comprising a first end proximate to the neck and a second end distal from the neck, the first end of the tip having a third diameter larger than the first diameter, the second end of the tip having a fourth diameter smaller than the third diameter, wherein a space is formed around the neck;
a wire jacket residing within the connector, wherein a portion of the wire jacket extends beyond the second end of the tip; and
the one or more wires residing within the wire jacket, wherein a portion of the one or more wires extend beyond the wire jacket.

6. The device of claim 3, wherein the power assembly comprises:
an inner housing comprising a channel, the channel comprising an outer opening and a shoulder proximate to the outer opening,
wherein when the second end of the connector assembly couples to the power assembly, the tip resides within the channel, wherein the shoulder of the inner housing resides within the space around the neck,
wherein the shoulder of the inner housing abuts the shoulder of the second end of the connector assembly and abuts the second end of the tip,
wherein the portion of the one or more wires extending beyond the wire jacket traverse the channel.

7. The device of claim 6, wherein the shoulder of the inner housing abutting the shoulder of the second end of the connector assembly and abutting the second end of the tip form a water resistant seal.

8. The device of claim 6, wherein the second end of the connector assembly is coupled to the power assembly without using an adhesive.

9. The device of claim 3, wherein the connector comprises a tube with an opening traversing the length of the connector, wherein the one or more wires reside within the opening.

10. The device of claim 1, wherein the vibrator motor assembly comprises a housing, wherein the motor resides within the housing, wherein the device further comprises a coupler coupled to the first end of the connector assembly and to a portion of the housing of the vibrator motor assembly.

11. The device of claim 10, wherein the coupler is coupled to the first end of the connector assembly and to a portion of the housing of the vibrator motor assembly using an adhesive.

12. The device of claim 3, wherein the vibrator motor assembly further comprises:
a front motor cover configured for the motor to reside within the front motor cover; and
a rear motor cover configured to couple to the first end of the connector assembly, wherein a coupling of the one or more wires to the motor resides within the rear motor cover.

13. The device of claim 12, wherein an inside surface of the rear motor cover comprises a chamfer coupled to the first end of the connector assembly.

14. The device of claim 12, wherein the rear cover comprises a flange at an end proximate to the first end of the connector assembly, the rear motor cover comprising one or more notches configured to engage a withdrawal string coupled to a tampon.

15. The device of claim 1, wherein the power assembly comprises:
a printed circuit board (PCB) assembly configured to control the motor; and a switch coupled to the PCB assembly.

16. A dysmenorrhea relief device, comprising:
a vibrator motor assembly, comprising a motor configured to vibrate at a given frequency;
a power assembly configured to control the motor; and
a connector assembly comprising a first end and a second end opposite the first end, the first end of the connector assembly coupled to the vibrator motor assembly, the second end of the connector assembly coupled to the power assembly,
wherein the connector assembly comprises a connector composed of a material that displace between 9 mm and 65 mm in a linear stress test of 78 mm±5 mm gage length of the material at 30 N,
wherein the connector assembly further comprises one or more wires with a first end and a second end opposite the first end, the first end of the one or more wires electrically coupled to the motor, the second end of the one or more wire electrically coupled to the power assembly, wherein the one or more wires reside within a length of the connector.

17. A dysmenorrhea relief device, comprising:
a vibrator motor assembly, comprising a motor configured to vibrate at a given frequency;
a power assembly configured to control the motor; and
a connector assembly comprising a first end and a second end opposite the first end, the first end of the connector assembly coupled to the vibrator motor assembly, the second end of the connector assembly coupled to the power assembly,
wherein the connector assembly comprises a connector composed of a material that displace between 9 mm and 65 mm in a linear stress test of 78 mm±5 mm gage length of the material at 30 N,
wherein the connector comprises a tube with an opening traversing the length of the connector, wherein the one or more wires reside within the opening.
